(19) United States
(12) Patent Application Publication
(10) Pub. No.: US 2024/0311475 A1
(43) Pub. Date: Sep. 19, 2024

(54) TOUCH SCREEN OVERLAY ATTACK PREVENTION

(71) Applicant: Microchip Touch Solutions Limited, Wokingham (GB)

(72) Inventors: Richard P. Collins, Southampton (GB); Lionel Nicolas Portmann, Lausanne (CH)

(21) Appl. No.: 18/605,419

(22) Filed: Mar. 14, 2024

Related U.S. Application Data
(60) Provisional application No. 63/490,429, filed on Mar. 15, 2023.

(51) Int. Cl. G06F 21/55; G06F 3/041; G06F 3/044

(52) U.S. Cl. CPC G06F 21/554; G06F 3/0416; G06F 3/0446; G06F 2221/034

(57) ABSTRACT

A method to obtain a codeword scrambled based, in part, on a code division multiplexing (CDM) pattern; generate a drive signal encoded with the scrambled codeword; and stimulate drive lines of a touch sensor in a touch screen over multiple measurement frames utilizing different patterns of the scrambled codeword for respective ones of the multiple measurement frames.

### CROSS-REFERENCE TO RELATED APPLICATION

This application claims the benefit under 35 U.S.C. § 119(e) of the priority date of U.S. Provisional Patent Application Ser. No. 63/490,429 filed Mar. 15, 2023, for Protecting from Touch Screen Overlay Attack, the contents and disclosure of which is incorporated herein in its entirety by this reference.

### BACKGROUND

Capacitive touch sensors are utilized in a variety of operational contexts, including touch screen terminals including for example, without limitation, Point of Sale (PoS) terminals. Touch screen terminals allow for entry of sensitive or personal information, such as, without limitation, payment card information, personal identification numbers (PIN), passcodes, for processing of transactions. PoS terminals are particularly vulnerable to external attacks that seek to intercept the entry of personal or sensitive information and steal the sensitive or other personal user information. A PCI security certification attests that a touch screen terminal includes mechanisms that reduces or eliminates the vulnerability of the touch screen terminal from external attacks.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram depicting a touch screen terminal and touch screen overlay in accordance with one or more examples;

FIG. 2 is a schematic diagram of a touch sensor system, in accordance with one or more examples;

FIG. 3 is a block diagram depicting an apparatus to generate encoded drive signals utilizing scrambled codes, in accordance with one or more examples;

FIG. 4 is a block diagram depicting the recovery of a touch screen location associated with a touch event, in accordance with one or more examples;

FIGS. 5A-5F are flow diagrams depicting a process of preventing an overlay attack, in accordance with one or more examples;

FIGS. 6A-6D are diagrams depicting the operations of applying a scrambling operation to a code division multiplexing (CDM) drive pattern to produce a scrambled codeword, in accordance with one or more examples;

FIGS. 7A, 7B are graphs depicting a quantized measurement of a touch encoded and decoded position in accordance with one or more examples;

FIGS. 8A, 8B are graphs depicting encoded drive signals associated with a measurement frame that are translated into a touch sense based on an incorrect code division in accordance with one or more examples; and

FIG. 9 is a diagram of a system in accordance with one or more examples of the disclosure.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is referred to as a flowchart, a flow diagram, a structure diagram, or a block diagram. The terms operation, acts, and block are used interchangeably to refer to the individual processes within a flow diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on a particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled,” and derivatives thereof, may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

In an overlay attack, a fraudulent layer or “overlay” is placed on top of a legitimate touch screen display to capture sensitive information such as, without limitation, passwords, PINs, or payment card numbers. A typical overlay may be a touch-sensitive surface that is difficult to distinguish from the original touch screen in which the user inputs information. The overlay surface copies the information entered by a user by determining the location of each touch entered on the touch screen responsive to the drive information provided by a legitimate touch screen driver. The location information is processed by an attacking touch controller that is remote which decodes the location information and retrieves the sensitive information.

In one or more examples, a touch screen terminal including, but not limited to, a touch screen of a PoS terminal, uses a scrambled Code Division Multiplexing (CDM) technique to protect against touch screen terminal attacks utilizing touch screen overlays. A touch screen controller using the scrambled CDM technique repeatedly and sequentially drives a set of signals, in a scrambled frame array pattern of encoded orthogonal signals, in a simultaneous manner, onto multiple parallel transmitter lines of a touch screen. The orthogonal code patterns may be input as scrambled encoded patterns. A code pattern is orthogonal to another code pattern when there is zero cross-correlation, which means that the sum of the result of multiplying the code patterns, bit-by-bit, over a period of time is equal to zero. In one or more examples, an orthogonal code may take the form of a Walsh code derived from a Hadamard matrix, or a Barker code as used in the IEEE 802.11 standard. When a touch input or touch event is received or sensed, the exact location of the touch event may be decoded by using the specific scrambled array of code patterns being applied when the touch was sensed. In embodiments of this disclosure, a touch input may also be synonymous with a touch event or a touch and refers to an application of pressure by touch by a human object such as, without limitation, a finger, or an inanimate object, such as without limitation, a stylus, to the surface of a touch screen. A touch screen overlay allows an attacker to sense the touch inputs. However, the attacker cannot access the scrambled array of code patterns needed to decode the exact location of the touch input. Therefore, it becomes very difficult to intercept the location of touches and determine the information being entered based on the touch events.

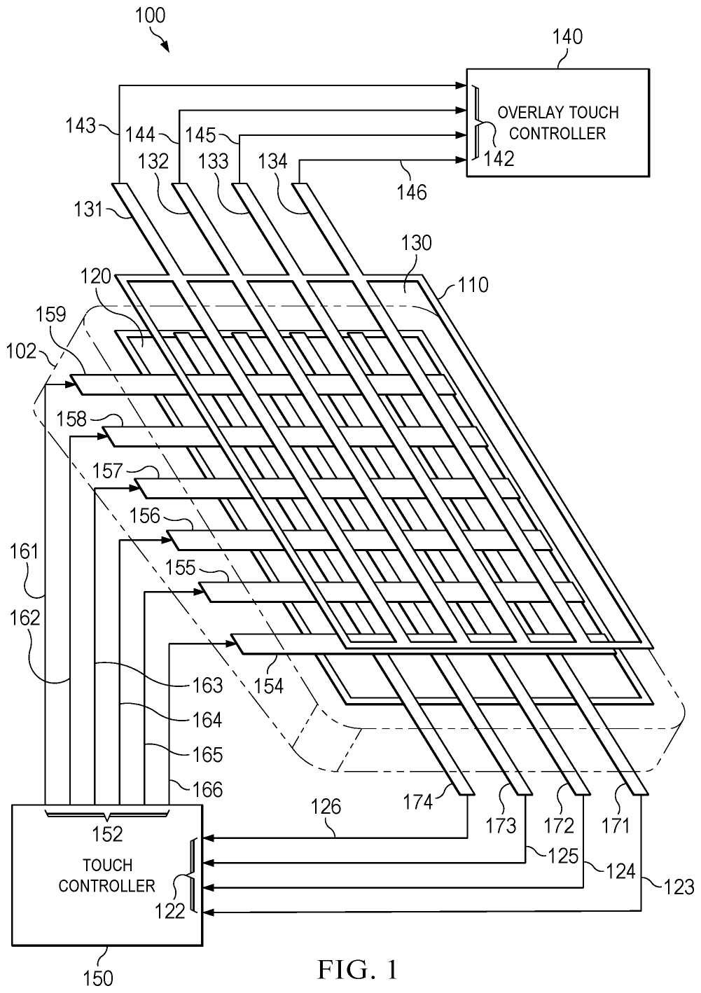

Turning to FIG. 1, a schematic diagram 100 depicts a touch screen terminal 102 and touch screen overlay 110 in accordance with one or more examples. Touch screen 120 may be composed of an array of one or more layers (not shown) that may include transparent layers, conductive layers, electrode layers, sensor layers and drive layers. Touch screen 120 may also include a display layer or a keypad (not shown) viewable by a user for user input. As shown, touch screen 120 includes an M by N touch sensor pattern including a set of M drive lines 154-159 arranged in rows and a set of N sense lines 171-174 arranged in columns, where M and N represent any positive integer and M may equal N in some embodiments. In an embodiment, the set of drive lines and set of sense lines may be integrated into one or more layers. It should be appreciated that although FIG. 1 includes a touch sensor pattern having sense lines 171-174 and drive lines 154-159, touch screen 120 may include any number of sense lines and drive lines. As shown, touch screen overlay 110 may have a set of N sense lines 131-134 equal to the N number of sense lines of touch screen 120. It must be noted that although the arrangement of the set of drive lines and set of sense lines are arranged in a matrix format, other arrangements are possible. Touch screen terminal 102 may include a touch controller 150, which may be implemented by a microcontroller, without limitation. Touch controller 150 may output sets of drive signals 161-166 onto the drive lines 154-159 of the touch screen 120 and process sense signals 122 received from the sense lines 123-126 of the touch screen 120.

Touch screen overlay 110 may not be visible to the naked eye and may be disposed within a transparent layer 130 separate from touch screen 120. Touch screen overlay 110 may be positioned directly over a display layer (not shown) of touch screen terminal 102 so that sense lines 131-134 of touch screen overlay 110 align directly over corresponding sense lines 171-174 of the touch screen 120 of touch screen terminal 102. The display layer may contain the symbols or characters of a user interface requiring a touch input by a user.

Touch screen overlay 110 may synchronize to the drive signals 161-166 generated by touch controller 150 to stimulate the drive lines 154-159. A touch input that affects the capacitance between one or more of the drive lines 154-159 and one or more of the sense lines 123-126 also affects the capacitance between the one or more drive lines 154-159 and one or more of corresponding sense lines 131-134 of touch screen overlay 110. The output sense signal patterns of touch screen 120 are thus copied by the output sense signals of the touch screen overlay 110 and may be routed to a microcontroller, such as overlay touch controller 140 that may be located remotely from the touch screen terminal 102 and touch controller 150.

During a contemplated operation, touch controller 150 may repeatedly stimulate drive signals 161-166 at the same time onto drive lines 154-159. The frequency of the repeated iteration of stimulating signals 152 provided to drive lines 154-159 may be set by the touch controller 150. A touch event to touch screen 120 may be sensed by the column of sense lines 171-174 and sense 123-126 are output to the touch controller 150 for processing. Similarly, the touch event to touch screen 120 may also be sensed in a simultaneous manner by sense lines 131-134 of the touch screen overlay 110 based on the stimulating signals to drive lines 154-159 of touch screen 120. The output sense signals 142 of the touch screen overlay 110 may be transmitted through sense lines 143-146 to a controller separate from the touch controller 150, such as overlay touch controller 140 for processing. The overlay touch controller 140 may be located at a location remote from the touch controller 150.

Touch controller 150 utilizes Code Division Multiplexing (CDM) to drive separate and orthogonal patterns to multiple drive lines simultaneously. The drive pattern applied to respective drive lines include pulses of the same or opposite polarity (e.g., 0 to 1 or 0 to −1, without limitation). The various drive patterns applied to the various drive lines are different and orthogonal to each other.

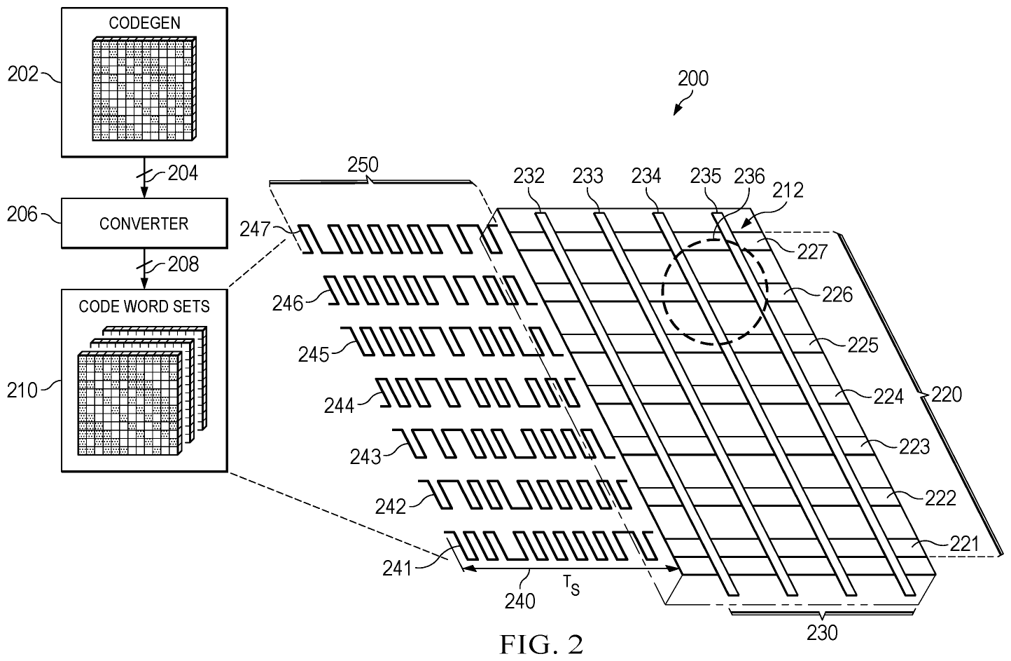

FIG. 2 is a schematic diagram of a touch sensor system 200 in accordance with one or more examples. Touch sensor system 200 may be part of the unseen display surface of a touch screen that detects and processes touch events through a touch sensor 212. The drive lines 221-227 of touch sensor 212 may be stimulated by the different encoded drive patterns 250 in multiple measurement frames. The encoded drive patterns 250 may be in a voltage pulse format. In examples of this disclosure, drive patterns and pulses are synonymous in meaning. The encoded drive patterns or encoded drive patterns or pulses 250 may be derived from a code generator, codegen 202, which may output a codeword 204 corresponding to each measurement frame. A converter 206 may input codeword 204 and apply a scrambler operator to the codeword 204 to produce scrambled codewords 208. A number of scrambled codeword may be stored as a part of codeword sets 210 where each codeword 208 of a codeword set 210 may correspond to a respective measurement frame. It should be recognized that the components of touch sensor system 200 are merely illustrative and non-limiting and other components and modifications may be possible.

The touch sensor 212 includes rows of transmitter electrodes or drive lines 220 and columns of receive electrodes or sense lines 230 which may form a grid structure on one or more layers of a mutual capacitance sensing system. It should be appreciated that although FIG. 2 illustrates a grid structure, any number of different types of structures or shapes may be formed by the drive lines 220 and sense lines 230.

The CDM technique of FIG. 2 utilizes orthogonal drive patterns to drive the multiple drive lines 220 simultaneously. A signal generator (not shown) may generate signals that are input to codegen 202. Codegen 202 may apply or spread a code across each respective input signal for each of the drive lines 220 to produce a stream of encoded pulses or a chip sequence. The chip sequences together form a codeword and in a set of codewords, each codeword is orthogonal to the other. In one non-limiting example, a chip sequence may represent a 1-chip as a voltage with positive polarity, +1V, and may represent a 0-chip as a voltage with negative polarity, −1V. Each chip sequence may be input to the converter 206 that scrambles the chip sequence in a randomized manner while maintaining the orthogonality between the chip sequences. Each scrambled chip sequence of a codeword set 210 may then be output to drive the drive lines 220 of the touch sensor 212 simultaneously. In one or more illustrative examples, respective chip sequences of the respective codewords are sent simultaneously, at a certain frequency during successive intervals of time. In CDM, each frame of a codeword set 210 represents encoded pulses 241-247 of negative or positive polarity.

Each of the drive lines 220 are stimulated by an individual one of the encoded pulses 241-247, during an iterative time interval or timeframe, Tₛ 240. Each of the encoded pulses 241-247 are orthogonal to all the other encoded pulses 241-247. Generally, two codes, or encoded pulses, are “orthogonal” if the cross-correlation between the codes or encoded pulses is zero. When two orthogonal codes or encoded pulses are multiplied together and integrated over a specific time interval, the result is zero. Orthogonal encoded pulses transmitted at the same time should not, or negligibly, interfere with each other. Each of the encoded pulses 241-247 may represent a set of pulses, some such pulses optionally having different polarities than other pulses, applied to drive lines 220. In one or more examples, the pattern of encoded pulses may be referred to as a codeword. The codeword may be applied to each respective drive line 221-227 of drive lines 220, and the drive pattern applied to each respective drive line 221-227 is different than, and orthogonal to, a totality of the respective patterns of encoded pulses applied to the other drive lines.

Touch sensor 212 may include one or more sensing regions, such as sensing region 236, on its surface. Sensing region 236 may be located at any number of various location coordinates over the surface of the touch sensor 212 to sense and measure touch inputs at sense lines 230. The sensing region 236 may receive encoded pules 241-247 on transmitter drive lines 221-227. Measurements corresponding to a touch event to sensing region 236 arc measured at receiver lines 232-235.

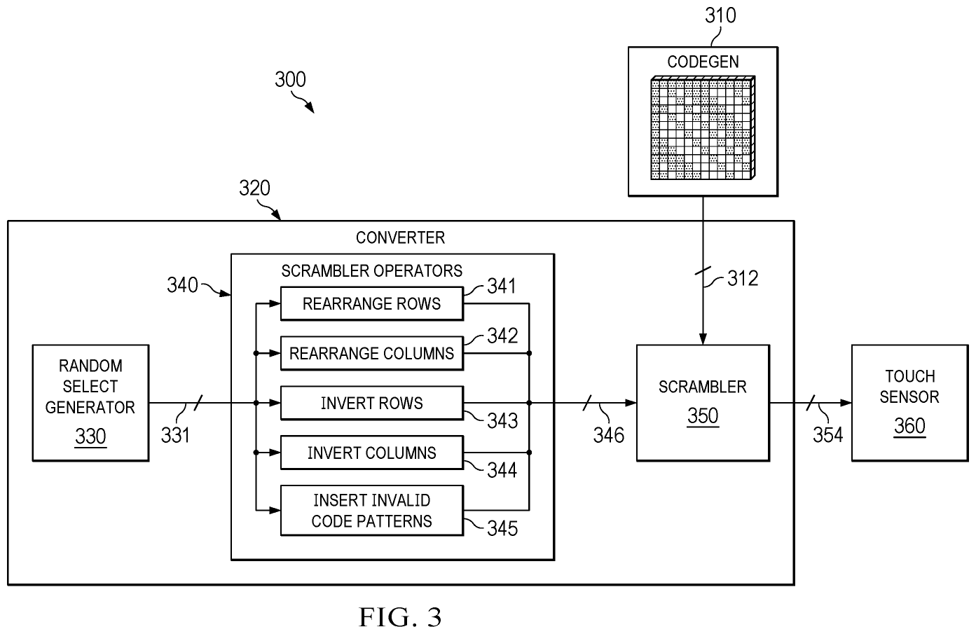

Turning next to FIG. 3, a block diagram depicting an apparatus 300 to generate a scrambled code is illustrated, in accordance with one or more examples.

In this example, apparatus 300 may include codegen 310, a converter 320, and a touch sensor 360. The converter 320 may include a random select generator 330, one or more scrambler operators 340, and a scrambler 350. The scrambler operators may include one or more of rearrange rows 341, rearrange columns 342, invert codeword rows 343 (“invert rows 343”), invert codeword columns 344 (“invert columns 344”), and insert invalid code patterns. 345. Invalid code patterns 345 (“invalid codewords 345”) may be codewords added to a frame that are not orthogonal to other codewords in the frame. It must be understood that the components of apparatus 300 are merely illustrative and non-limiting and other components and modifications may be possible.

In FIG. 3, the converter 320 may select from one or more scrambler operators 340 in a randomized manner. The randomized manner may be determined by a random select generator 330 or based on the output thereof. Random select generator 330 may generate a selection value 331 through circuitry associated with a true random number generator or a pseudo random number generator. Any suitable source of randomness for a given operating condition or application may result in random select generator 330 utilizing a random number generator or a pseudo-random number generator to produce a selection value 331. Non-limiting examples of sources of randomness include an analog noise source, such as a resistor and amplifier to generate a sufficient amplitude to drive an analog-to-digital converter, a digital noise source such as one or more variable or fixed frequency ring oscillators, or a combination thereof, without limitation.

The selection value 331 may be utilized to select from one or more scrambler operators 340. The scrambler operator(s) 346 may be selected from one or more scrambler operators 340 which may include, without limitation, rearrange rows 341, rearrange columns 342, invert rows 343, invert columns 344 and one or more invalid code patterns 345. Scrambler operators 340 may output selected scrambler operator(s) 346 to scrambler 350 that indicate a selection of one or more of the scrambler operators 340 for use by scrambler 350. The selected scrambler operator(s) 346 may be utilized by scrambler 350 in scrambling the codeword frame provided by codegen 310.

In one or more non-limiting examples, codegen 310 may generate a frame or matrix that includes sequences of codewords which may represent patterns of encoded pulses for stimulating the drive lines of touch sensor 360. Respective encoded pulse pattern codewords may be orthogonal to the other encoded pulse pattern codewords. In one or more examples, each symbol of the codeword may be considered a chip of the codeword. A ‘1’ chip may be +1V to indicate a pulse with a positive polarity and a “0” chip may be represented by −1 V to indicate a pulse with a negative polarity, respectively. In one or more examples, a two-dimensional (2D) array of chip values may be formed where the number of chip values in a row of the array corresponds to the number of pulses per measurement frame. The rows correspond to respective drive lines of the touch sensor 360. In this example, respective chip values in a row correspond to respective encoded pulses to be driven on respective drive lines of touch sensor 360.

Scrambler 350 may receive a codeword 312 for each encoded pulse in a predetermined time frame, such as encoded pulses 241-247 in time frame Tₛ 240, from codegen 310. The codeword 312 may then be scrambled within the predetermined time frame, according to a selected scrambler operator(s) 346, to generate a sequence of scrambled code chips or codewords 354, at least partially responsive to the codewords 312 received in the time frame from codegen 310. Scrambler 350 may perform one or more scrambling operations, based on the selected scrambler operator(s) 346 from one or more scrambler operators 340. The scrambled codewords 354 that may be obtained based on the selected scrambler operator(s)346 may be different from the codeword 312 input to the scrambler 350. In one or more examples, scrambler operator 346 may indicate multiple scrambler operators to be used in the scrambler 350 operations. Scrambler 350 may generate and output unique or different scrambled codewords 354 for each respective measurement frame based on one or more defined scrambler operators 340. In one or more examples, respective scrambled codewords in a respective time frame may be chosen so they are orthogonal with other respective scrambled codewords in the respective time frame.

The “codeword” represents a pattern of symbols, or chip sequences, utilized to encode drive signals, such as encoded pulses 241-247 of FIG. 2, applied simultaneously to respective drive lines 220, such as drive lines 221-227 of a touch sensor 360 during a respective measurement frame. Non-limiting examples of scrambler operators may perform one or more operations on codewords to rearrange rows, rearrange columns, invert rows, invert columns, and insert invalid code patterns, as discussed below without limitation. In one or more examples of this disclosure, the operations of rearrange rows and rearrange columns may be considered to be the same as a shuffling operation. The defined scrambler operators of rearrange rows, rearrange columns, invert rows, invert columns may perform operations that maintain the orthogonality of a codeword set. The scrambler operator of insert invalid code patterns may insert a code pattern that is non-orthogonal with respect to the other code patterns into a codeword set.

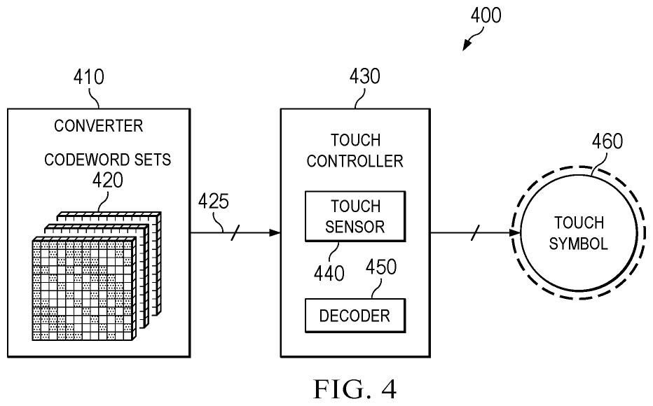

FIG. 4 is a block diagram depicting the recovery of a touch screen location associated with a touch event, in accordance with one or more examples. In this example, diagram 400 may include codeword sets 420 of converter 410, a touch controller 430 and an original touch symbol 460. Touch controller 430 may also include a touch sensor 440 and a decoder 450. It must be understood that the components of diagram 400 are merely illustrative and non-limiting and other components and modifications may be possible.

Operationally, touch controller 430 may receive one or more of the codeword sets 420 that were scrambled by one or more scrambler operators and used to encode the multiple frames of drive signals driven onto drive lines of touch sensor 440. Touch controller 430 may also receive the measurement signals of the sense lines of the touch sensor 440. Touch controller 430 may process the measurement signals of the sense lines to determine the presence of, and location of, a touch event. Touch processing includes, in a non-limiting manner, processes activated by the touch controller 430 that identifies a touch event or location coordinates of a touch event. A cover layer or surface (not shown) may be positioned to cover a touchscreen such as touch sensor 212 and a touch to a region of the touchscreen, such as sensing region 236, may include symbols, such as numbers or characters which may be relevant to a particular touchscreen application. The location coordinates of the touch event may correspond to a particular symbol in a particular sensing region, such as sensing region 236 illustrated in FIG. 2. The processing by the touch controller 430 decodes the location coordinate of a touch event. The touch coordinates may correspond to touch symbol 460.

Decoder 450 may receive the scrambled codewords 425 used to encode the drive signals of touch sensor 440 from converter 410. Decoder 450 may decode the measured sense signals, such as the encoded sense signals, such as encoded sense lines 124-126, for a given measurement frame utilizing scrambled codewords 425 associated with the given measurement frame. As noted above, different scrambled codewords 425 may be generated for each frame.

As a result, an overlay touch controller, such as that illustrated by overlay touch controller 140 in FIG. 1, will not be able to decode the sense signals measured by touch sensor 440 without access to the scrambled codewords 425. The scrambled codeword 425 generated by converter 410 increases the difficulty for an attacker to learn or guess a decoded pattern or touch symbol 460.

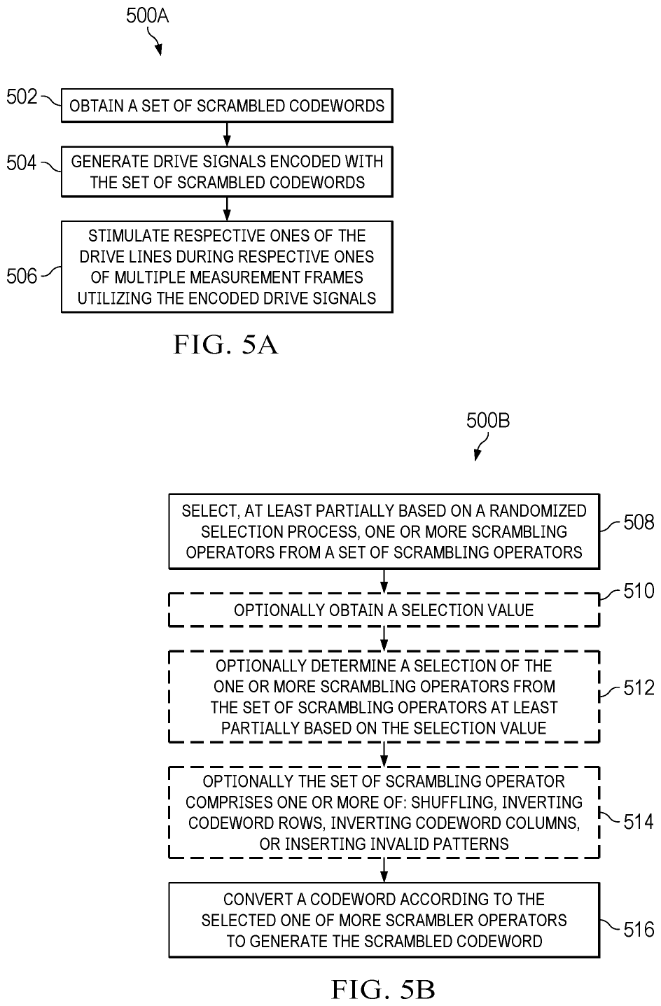

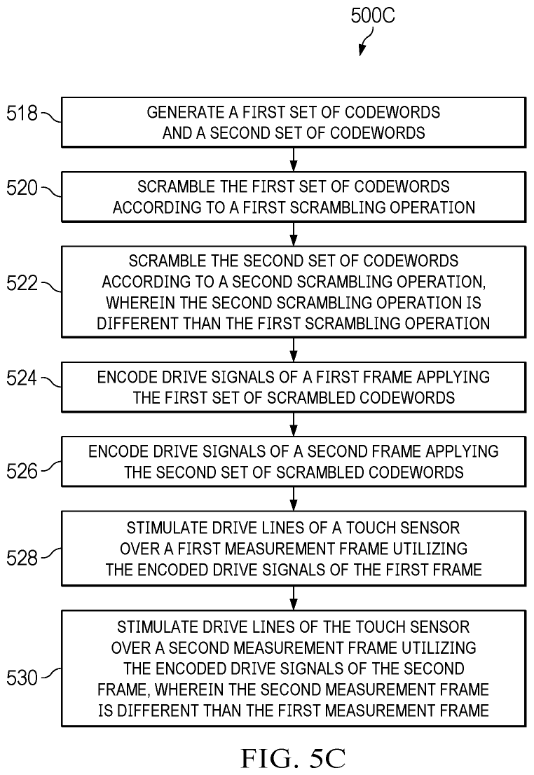

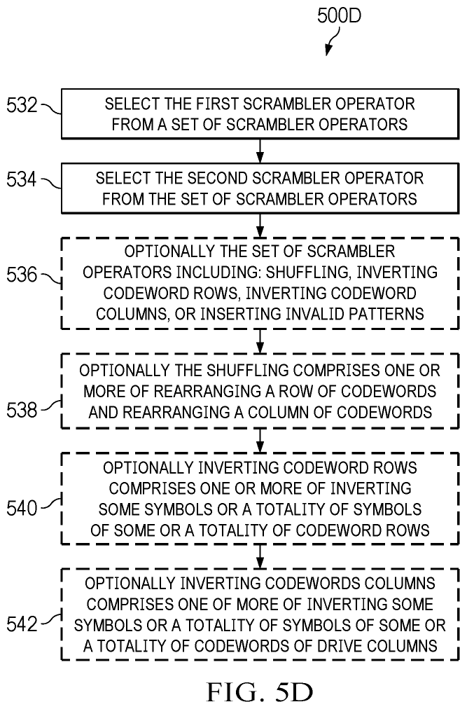

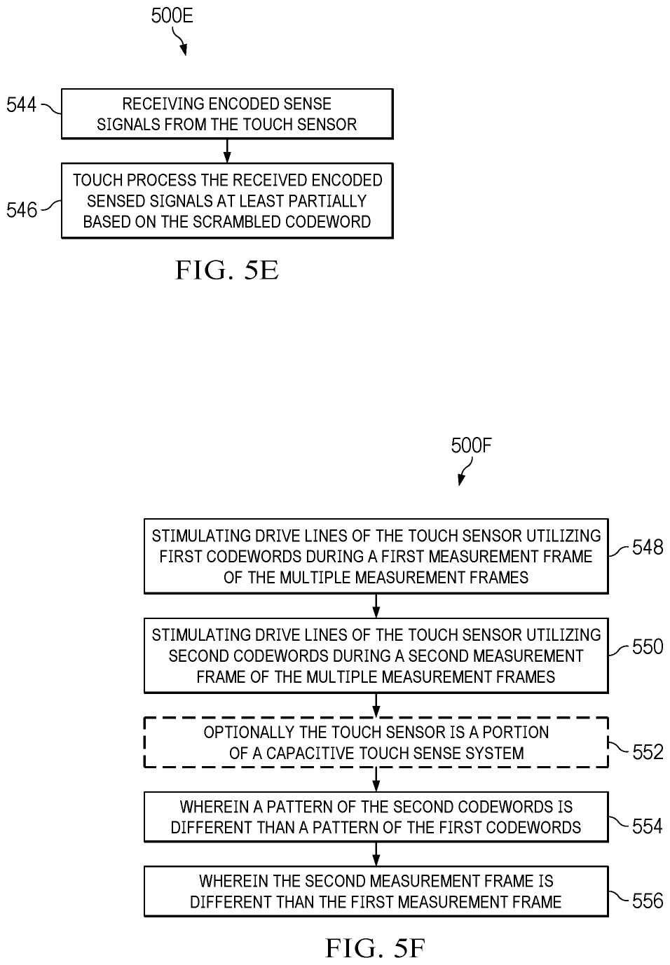

FIGS. 5A-5F are flow diagrams depicting a process of preventing an overlay attack, in accordance with one or more examples. Although the example processes of 500A-500F depict a particular sequence of operations, the sequence may be altered without departing from the scope of the present disclosure. For example, some of the operations depicted may be performed in parallel or in a different sequence that does not materially affect the function of the process. In other examples, different components of an example device or system that implements the processes of 500A-500F may perform functions at substantially the same time or in a specific sequence.

In one or more non-limiting examples, FIG. 5A discloses process 500A which depicts the operation of generating drive signals. At block 502, the process obtains a set of scrambled codewords. The set of scrambled codewords may be sequences of chips where a +1 represents a specific chip sequence and a 0 is represented by +1 or the negation of the chip sequence that represents +1.

At block 504, drive signals may be encoded by the set of scrambled codewords. Notably, the drive signals are orthogonal to each other, since the obtained scrambled codewords are orthogonal to each other, and each drive signal may drive a separate drive line of the touch screen. At block 506, respective ones of the drive lines of the touch screen are driven during a respective one of multiple measurement frames utilizing the drive signal encoded with the scrambled codeword. Respective ones of multiple measurement frames of encoded drive signals may stimulate all the drive lines in a simultaneous manner over a period of time.

FIG. 5B is a flow diagram depicting the process 500B for generating a scrambled codeword. At block 508, the operation selects, at least partially based on a randomized selection process, one or more scrambling operations from a set of scrambling operations. The scrambling operation may be based on a randomized selection process. The randomized selection process may optionally include obtaining a selection value at block 510 based on a random number generator or pseudo-random number generator. At optional block 512, a selection of one or more scrambling operations from a predetermined set of scrambling operations may be determined based at least in part on the random value obtained. It must be noted that the scrambling operations used may preserve the orthogonality of the codeword sequences. At block 514, the set of scrambling operators may optionally be selected from one or more scrambling operators including shuffling, inverting codeword rows, inverting codeword columns, or inserting invalid patterns. In one or more examples of this disclosure, the shuffling operation may be operations which rearranges the position of a respective row or column of a codeword. At block 516, a scrambled codeword is generated according to a selected one or more scrambling operators to generate the scrambled codeword.

In one or more non-limiting examples, FIG. 5C is a flow diagram depicting a process 500C of stimulating the drive lines of a touch screen. The process may begin at block 518 where a first codeword and a second codeword may be generated in accordance with one or more examples. Although reference is made to a first codeword and a second codeword, it should be recognized there may be more than two codewords generated, where each codeword is orthogonal to the other and each codeword has a dedicated drive line. It should also be recognized that the terms first and second are not meant to be limited in terms of order of occurrence. At block 520, the first codeword set may be scrambled according to a scrambler operator that may be selected to correspond to the first codeword set. At block 522, a second codeword set may be scrambled based on applying another scrambler operator that may be different from the scrambler operator applied to the first codeword set. At block 524, a first drive pattern of a first frame may be encoded utilizing the scrambled first codeword set. At block 526, a second drive pattern of a second frame may be encoded utilizing the scrambled second codeword set.

At block 528, the encoded drive patterns or encoded pulses of a measurement frame, such as measurement timeframe Tₛ 240 illustrated in FIG. 2, may be driven to stimulate or excite the drive lines of a touch sensor. In one or more examples, the drive lines of a touch sensor may be horizontal. The measurement frames containing the encoded pulses may be driven in an iterative manner, one frame following the other, onto the drive lines. At block 530, according to one or more non-limiting examples, the drive lines of the touch sensor may be stimulated by a second measurement frame utilizing a second set of encoded pulses or encoded drive signals.

FIG. 5D is a flow diagram depicting a process 500D of selecting one or more scrambling operators. In one or more non-limiting examples, at block 532, a first scrambling operator may be selected from a set of scrambler operators. As illustrated FIG. 3, the scrambler operators 340 may include, without limitation, rearrange rows 341, rearrange columns 342, invert rows 343, invert columns 344 and insert invalid code patterns 345. One or more scrambler operators 340 may be applied to a set of orthogonal codewords within a first frame. The scrambler operators may be simultaneously applied frame-by-frame to all the transmitter lines of a touch sensor and each scrambled codewords maintain its orthogonality within the plurality of codewords. In a non-limiting example, at block 534, a second scrambling operator may be selected from the set of scrambling operators to be applied to a set of orthogonal codeword within a second frame. It should be noted that the terms first and second are non-limiting and are used to refer to a unique or different entity instead of a particular order or sequence.

Optionally, at block 536, the set of scrambler operators may result in scrambling operations that include shuffling, inverting codeword rows, inverting codeword columns or inserting invalid patterns. In addition, optionally, at block 538, a scrambling operation that includes shuffling may include one or more of rearranging a row of codewords and rearranging a column of codewords. In one or more examples, rearranging a row or column may include reversing the order of the chips in the chip sequence of a row or column. In other examples, rearranging a row or column may include interchanging or swapping a position of a first row with the position of a second row in a frame, and similarly interchanging or swapping a position of a first column with the position of a second column in a frame. Optionally, at block 540, a scrambling operation of inverting codeword rows includes one or more of inverting some or up to a totality of codeword rows or inverting one some symbols or a totality of symbols. In addition, optionally, at block 542, a scrambling operation that includes inverting codeword columns includes one or more of inverting some symbols or a totality of symbols or some or a totality of codewords in drive columns.

FIG. 5E is a flow diagram that depicts a process 500E of recovering an original touch symbol is illustrated in accordance with one or more examples. At block 544, encoded sense signals are received from the touch sensor. In one or more non-limiting examples, the sense lines are vertically aligned in an electrode layer that is perpendicular to the drive lines. At block 546, the received encoded sense signals are touch-processed, at least partially, on the scrambled codeword so that a touch event or location coordinates of a touch event may be identified.

FIG. 5F is a flow diagram that depicts a process 500F that illustrates a process of stimulating drive lines in accordance with one or more examples. At block 548, drive lines of a touch sensor are stimulated utilizing first codewords during a first measurement frame of multiple measurement frames. At block 550, drive lines of the touch sensor are stimulated utilizing second codewords during a second measurement frame of multiple measurement frames. It must be recognized that the terms “first” and “second” are used in a non-limiting manner to distinguish one entity from another. Any number of non-limiting numerical terms, for example, “third,” “fourth,” may be used in accordance with one or more examples that may have multiple drive lines corresponding to one or more measurement frames. Optionally, at block 552, it must be noted that the touch sensor may form a portion of a capacitive touch sensor system of a touch screen. It must be recognized at block 554 that a pattern of the second codewords is different than a pattern of the first codewords. Also, it must be recognized at block 556 that the second measurement frame is different than the first measurement frame.

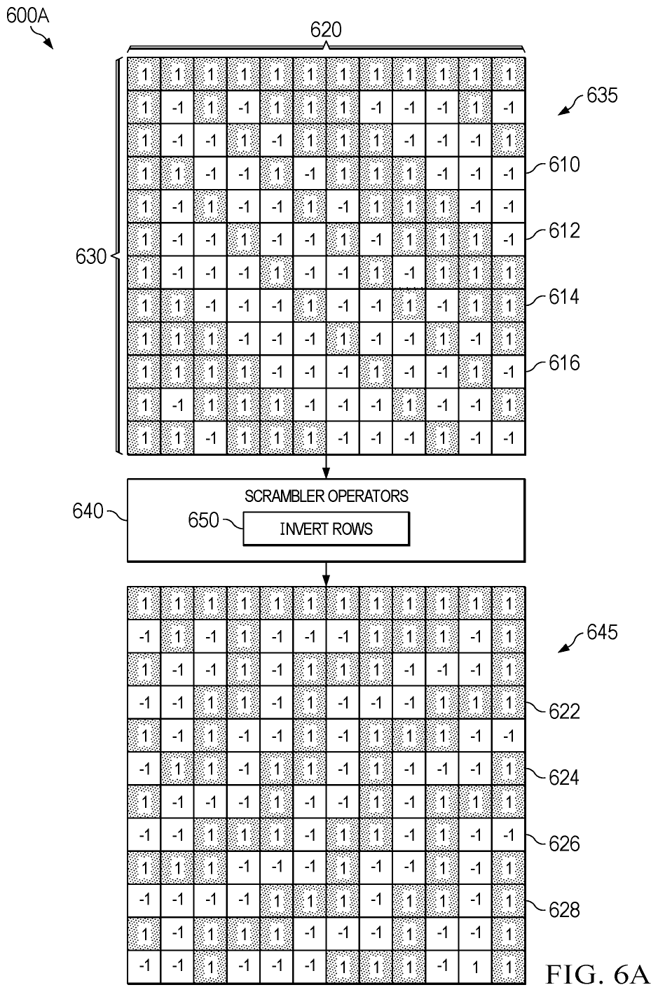

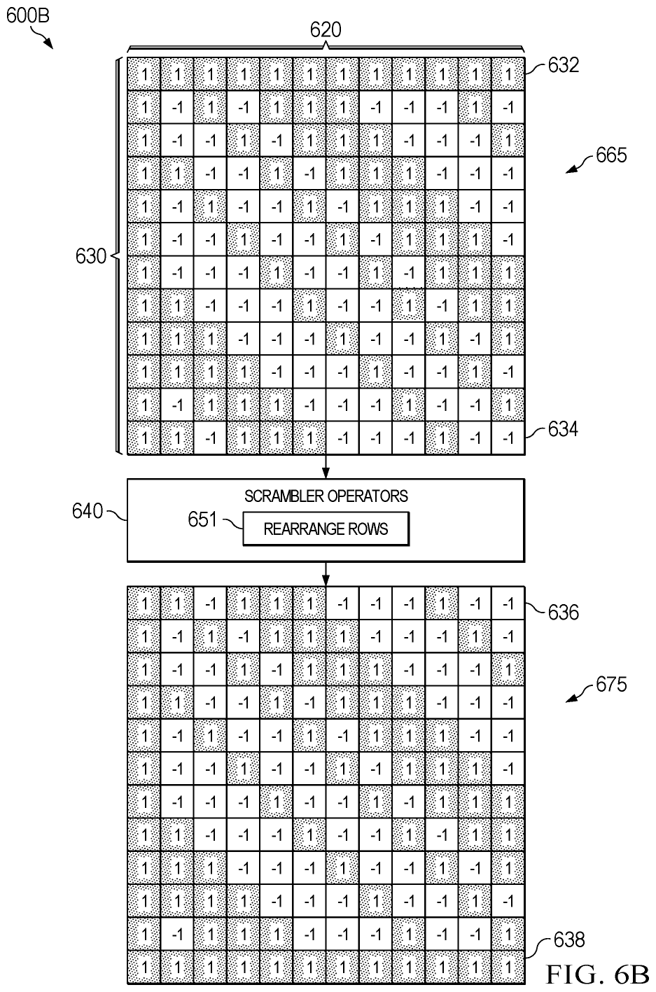

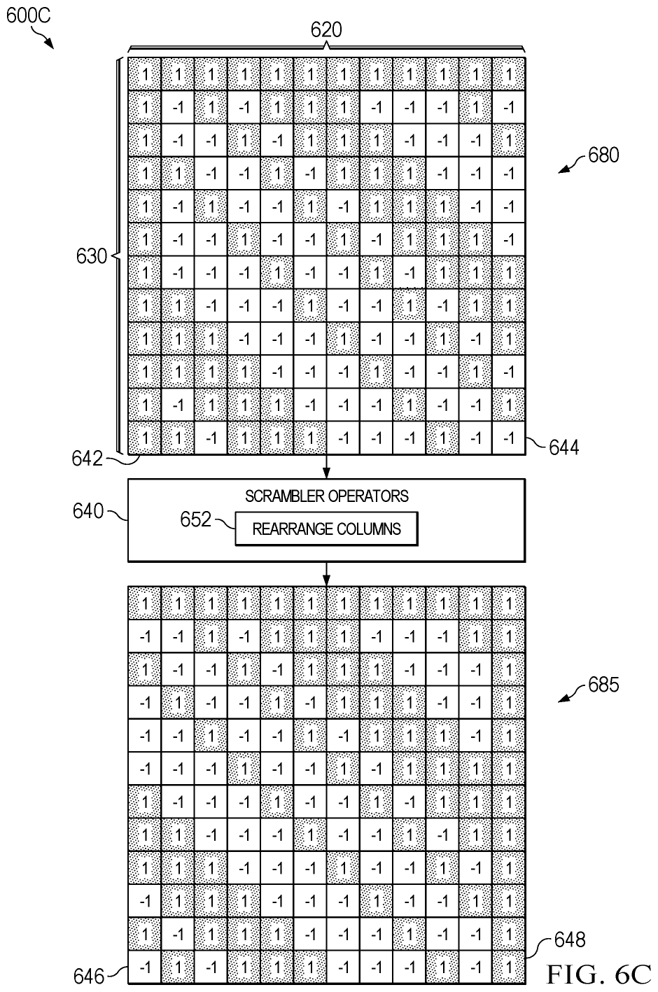

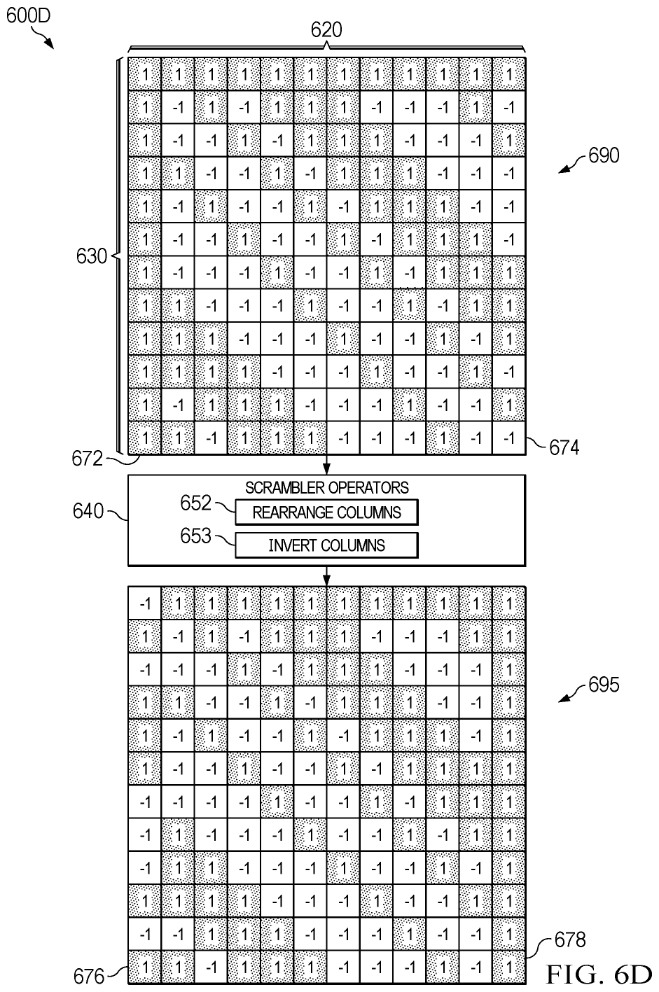

FIGS. 6A-6D are diagrams that depict the operations of applying a scrambling operation to a CDM drive pattern to produce a scrambled codeword, in accordance with one or more examples. Although the examples of 600A-600D depict one or more sequences of scrambling processes, the scrambling processes and operations may be altered without departing from the scope of the present disclosure. For example, some of the operations depicted may be performed in parallel or in a different sequence that does not materially affect the function of the process. In other examples, different code patterns or scrambling operators of an example device or system that implements the processes of 600A-600D may perform functions at substantially the same time or in a specific sequence. As detailed in FIG. 3, scrambler operators may include, without limitation, rearrange rows, rearrange columns, invert rows, inverts columns, and insert invalid code patterns.

In one or more non-limiting examples, FIG. 6A is a schematic diagram 600A depicts the production of a CDM-based encoded or scrambled array. Codeword set 635, representing a CDM codeword set. Scrambler operators 640 are applied to one or more codeword sequences of codeword set 635 to produce a scrambled codeword set 645. The input codeword set 635 is represented by +1V and −1V symbols for an N-CDM input touch sensor, where N is a positive integer that represents a number of channels. The +1V symbol may represent a 1 chip and the −1V symbol may represent a 0 chip. In one one-limiting example, N may be equal to 12. It must be recognized that the number of rows 630 and the number of columns 620 is arbitrary and a grid structure may not be necessary.

In schematic diagram 600A, scrambler operator invert rows 650 is selected from a number of the scrambler operators 640. In a non-limiting example, the invert rows 650 scrambler operator may be applied to convert a number of chip sequences in codeword set 635 to produce a scrambled codeword set 645. Table 1 illustrates the operation of invert rows 650 on codeword sequence 610 of codeword set 635 to produce codeword sequence 622 of scrambled codeword set 645.

TABLE 1

| | | | | | | | | | | | |
|---|---|---|---|---|---|---|---|---|---|---|---|
| 1 | 1 | −1 | −1 | 1 | −1 | 1 | 1 | 1 | −1 | −1 | −1 |

Codeword sequence 610 codeword set 635

| | | | | | | | | | | | |
|---|---|---|---|---|---|---|---|---|---|---|---|
| −1 | −1 | 1 | 1 | −1 | 1 | −1 | −1 | −1 | 1 | 1 | 1 |

Codeword sequence 622 codeword set 645

The scrambler operator invert rows 650 may operate to scramble a codeword sequence by inverting the polarity of each bit in a chip sequence. A similar conversion is illustrated in Table 2 where scrambler operator invert rows 650 may convert codeword sequence 612 of codeword set 635 to codeword sequence 624 of scrambled codeword set 645.

TABLE 2

| | | | | | | | | | | | |
|---|---|---|---|---|---|---|---|---|---|---|---|
| 1 | −1 | −1 | 1 | −1 | −1 | 1 | −1 | 1 | 1 | 1 | −1 |

Codeword sequence 612 codeword set 635

| | | | | | | | | | | | |
|---|---|---|---|---|---|---|---|---|---|---|---|
| −1 | 1 | 1 | −1 | 1 | 1 | −1 | 1 | −1 | −1 | −1 | 1 |

Codeword sequence 624 codeword set 645

Additional conversion examples using the scrambler operator invert rows 650 are illustrated in Table 3 and Table 4. Table 3 illustrates the conversion of codeword sequence 614 to a scrambled codeword sequence 626.

TABLE 3

| | | | | | | | | | | | |
|---|---|---|---|---|---|---|---|---|---|---|---|
| 1 | 1 | −1 | −1 | −1 | 1 | −1 | −1 | 1 | −1 | 1 | 1 |

Codeword sequence 614 codeword set 635

| | | | | | | | | | | | |
|---|---|---|---|---|---|---|---|---|---|---|---|
| −1 | −1 | 1 | 1 | 1 | −1 | 1 | 1 | −1 | 1 | −1 | −1 |

Codeword sequence 626 codeword set 645

Table 4 illustrates the conversion of codeword sequence 616 to a scrambled codeword sequence 628.

TABLE 4

| | | | | | | | | | | | |
|---|---|---|---|---|---|---|---|---|---|---|---|
| 1 | 1 | 1 | 1 | −1 | −1 | −1 | 1 | −1 | −1 | 1 | −1 |

Codeword sequence 616 codeword set 635

| | | | | | | | | | | | |
|---|---|---|---|---|---|---|---|---|---|---|---|
| −1 | −1 | −1 | −1 | 1 | 1 | 1 | −1 | 1 | 1 | −1 | 1 |

Codeword sequence 628 codeword set 645

FIG. 6B is a schematic diagram 600B depicting a conversion operation in which one of the scrambler operators 640 is applied to a codeword set 665 to produce a scrambled codeword set 675. In one or more non-limiting examples, 600B applies a selected scrambler operator rearrange rows 651 from scrambler operators 640. The rearrange rows operator rearranges a codeword sequence 632 of codeword set 665 and a codeword sequence 634 of codeword set 665 by swapping the locations of codeword sequence 632 and codeword sequence 634 in codeword set 665 to produce the scrambled codeword set 675. As illustrated in the non-limiting example of 600B, codeword sequence 632, is illustrated in a first row of codeword set 665.

Codeword Sequence 632 codeword set 665

| | | | | | | | | | | | |
|---|---|---|---|---|---|---|---|---|---|---|---|
| 1 | 1 | 1 | 1 | 1 | 1 | 1 | 1 | 1 | 1 | 1 | 1 |

Codeword sequence 634 is illustrated in the last row of codeword set 665.

Codeword sequence 634 codeword set 665

| | | | | | | | | | | | |
|---|---|---|---|---|---|---|---|---|---|---|---|
| 1 | 1 | −1 | 1 | 1 | 1 | −1 | −1 | −1 | 1 | −1 | −1 |

In scrambled codeword set 675, the position of codeword sequence 632 is relocated to a last row as shown by codeword sequence 638, and the position of codeword sequence 634 is relocated to a first row as shown by codeword sequence 636. Scrambler operator rearrange rows 651 operates to swap the locations of rows without changing the bits of a chip sequence.

FIG. 6C is a schematic diagram 600C depicting a conversion operation in which scrambler operator 640 is applied to a codeword set 680 to produce scrambled codeword set 685. In one or more non-limiting examples, a scrambler operator rearrange columns 652 may operate to swap the locations of one or codeword sequences in column of a codeword set without changing the bits in the column of the chip sequence. As illustrated in the non-limiting example of 600C, codeword set 680 includes a codeword sequence 642 and a codeword sequence 644 as illustrated in Table 5 and Table 6, respectively.

TABLE 5
Codeword sequence 642
1
1
1
1
1
1
1
1
1
1
1
1

TABLE 6
Codeword sequence 644

1
−1
1
−1
−1
−1
1
1
1
−1
1
−1

Scrambler operator rearrange column 652 interchanges a columnar codeword sequence 642 with a columnar codeword sequence 644 in codeword set 680 to generate scrambled codeword set 685. In scrambled codeword set 685, codeword sequence 644 in codeword set 680 appears as codeword 646 in scrambled codeword set 685 in the former location of codeword sequence 642. Similarly, codeword sequence 642 in codeword set 680 appears as codeword 648 in scrambled codeword set 685 in the former location of codeword sequence 644.

FIG. 6D is a schematic diagram 600D depicting a conversion in which one or more scrambler operators 640 is applied to codeword set 690 to generate scrambled codeword set 695. In one or more non-limiting examples, the process of 600D applies a scrambler operator rearrange columns 652 and a scrambler operator invert columns 653 to generate the scrambled codeword set 695.

Rearrange columns 652 may rearrange the position of a column with codeword sequence 672 of codeword set 690 to appear as codeword 678 column of scrambled codeword set 695. Invert columns 653 may be applied to invert the polarity of each chip in the chip sequence columns of codeword sequence 672 and codeword 674. In sum, the location of codeword 674 of codeword set 690 is swapped with the location of codeword 674 in codeword set 690 and the bit polarity of each codeword is inverted to produce codeword 676 and codeword 678 of scrambled codeword set 695.

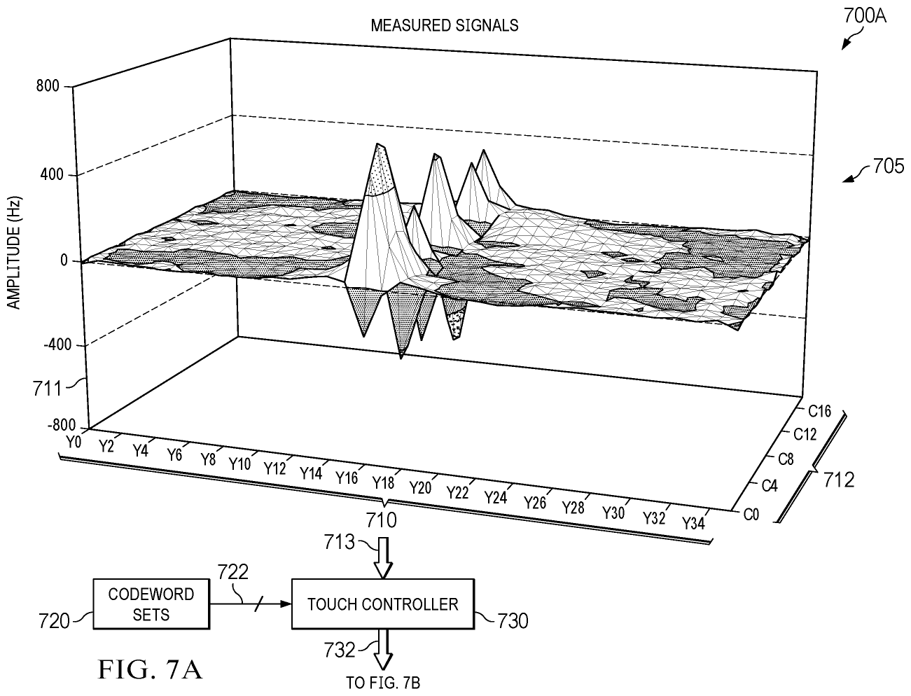

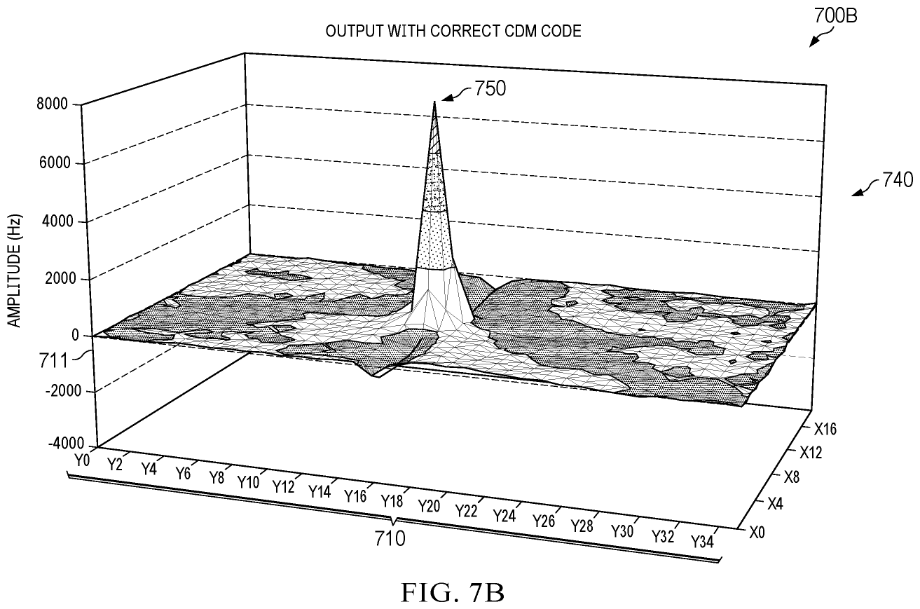

FIGS. 7A, 7B are graphs depicting a quantized measurement of a touch encoded event that is decoded, in accordance with one or more examples. FIG. 7A is a graph 700A that may include a quantized measurement of a measurement frame 705.

The measurement frame 705 represents the signal strengths across the columns of a touch surface when a touch is sensed, responsive to the drive signals of the measurement frame 705. In one non-limiting example, the X-axis 710 with Y0-Y34 and Z-axis 712 with C0-C16 represent location coordinates of a touch screen terminal, such as illustrated in touch screen terminal 102 of FIG. 1. Y0-Y34 represent sense lines that are encoded, and C0-C16 represent drive lines. The Y-axis 711 shows signal strength information, measured in amplitude. The set of peaks in measurement frame 705 represent a location information of a touch event that is encoded based on scrambler operators. The touch controller 730 inputs the encoded sense signals 713 and generates an output 732 based on one or more codeword sets 720 used to encode the drive lines of the touch terminal. The location of a touch event may be used to determine the original symbol or symbols corresponding to the location of the touch event. The encoded sense signals of measurement frame 705 requires the information from codeword sets 720 to determine the correct location of a touch event. A touch controller 730 may use a selected codeword set output 722 from codeword sets 720 used to encode the drive pattern to decode the encoded sense signals 713. Invalid patterns that may be included in the codeword sets 720 are discarded by the touch controller 730.

FIG. 7B is a graph 700B that illustrates a quantized measurement of the touch decoded position in accordance with one or more examples. The peak 750 of quantized measurement frame 740 corresponds to a correctly decoded position processed by touch controller 730. A correctly decoded position will result in a single peak with a high amplitude such as peak 750. Peak 750 may correspond to a touch event and may correlate to a symbol on a display layer.

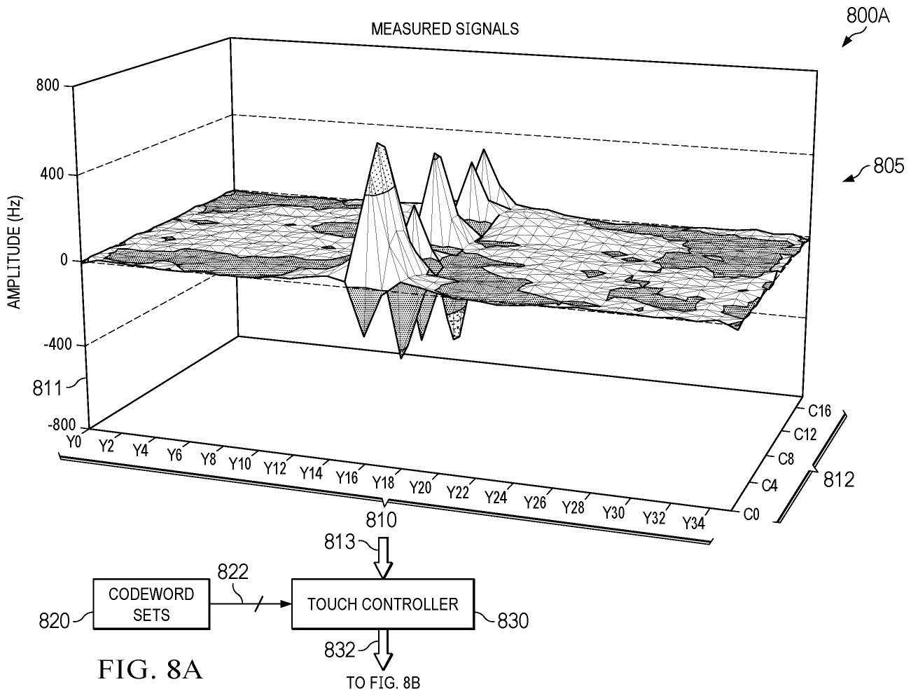

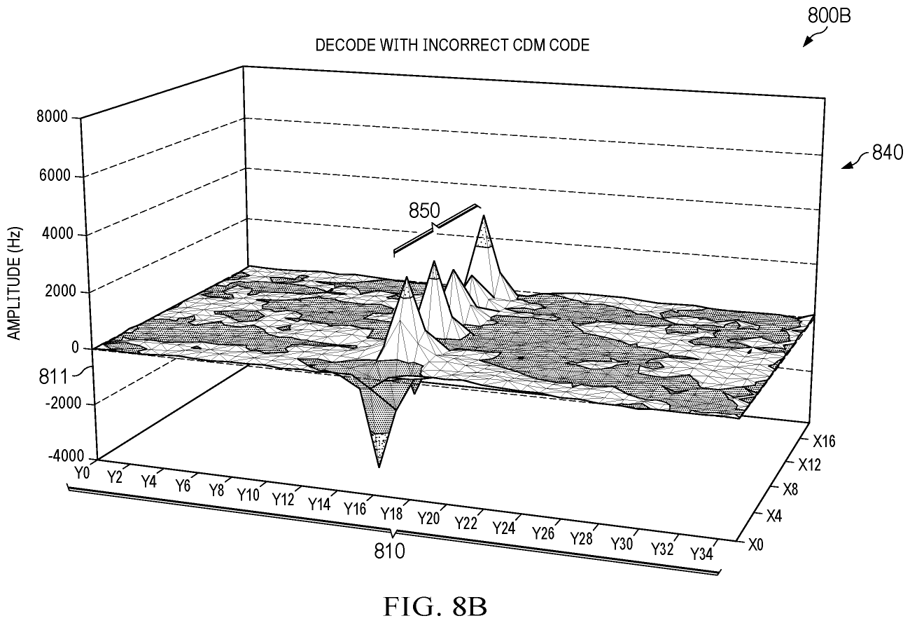

FIGS. 8A, 8B are graphs depicting a quantized measurement of a touch encoded event that is decoded, in accordance with one or more examples. FIG. 8A is a graph 800A that includes a quantized measurement of a measurement frame 805.

As in graph 700A of FIG. 7A, the encoded sense signals require the scrambled codeword information to correctly determine the location of a touch event. The touch controller 830 may use the same codeword sets provided by the codeword sets 820 to encode the sense signals to decode the encoded sense signals.

The measurement frame 805 represents the signal strengths across the columns of a touch surface when a touch is sensed, responsive to the drive signals of the measurement frame 805. In one non-limiting example, the X-axis 810 with Y0-Y34 and Z-axis 812 with C0-C16 represent location coordinates of a touch screen terminal, such as illustrated in touch screen terminal 102 of FIG. 1. Y0-Y34 represent sense lines that are encoded, and C0-C16 represent drive lines. The Y-axis 811 shows signal strength information, measured in amplitude. The set of peaks in measurement frame 805 represent a location information of a touch event that is encoded based on scrambler operators. The touch controller 830 inputs the encoded sense signals 813 and generates an output 832 based on one or more codeword sets 820 used to encode the drive lines of the touch terminal. The location of a touch event may be used to determine the original symbol or symbols corresponding to the location of the touch event. The encoded sense signals of measurement frame 805 requires the information from codeword sets 820 to determine the correct location of a touch event. A touch controller 830 may use a selected codeword set output 822 from codeword sets 820 used to encode the drive pattern to decode the encoded sense signals 813. Invalid patterns that may be included in the codeword sets 820 are discarded by the touch controller 830.

FIG. 8B is a graph 800B that illustrates a quantized measurement of the touch decoded position in accordance with one or more examples. A correctly decoded position results in a single peak with a high amplitude such as peak 750 of FIG. 7B. However, the multiple peaks 850 of quantized measurement frame 840 indicate that an incorrect codeword may have been used to decode the encoded sense signal and therefore a single peak cannot be obtained. Without the original scrambled codeword used to encode the sense signals, it may be difficult to decode the encoded touch information. The location of the touch event may not be determined by an attacker that does not have the original codeword used to encode the sense signals.

It will be appreciated by those of ordinary skill in the art that functional elements of examples disclosed herein, including for example, without limitation, functions, operations, acts, processes, or methods, may be implemented in any suitable hardware, software, firmware, or combinations thereof.

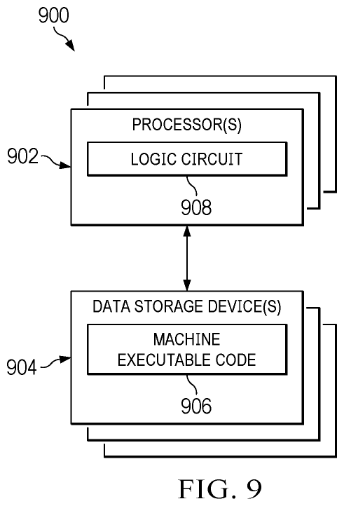

FIG. 9 is a diagram of a system in accordance with one or more examples of the disclosure. FIG. 9 illustrates non-limiting examples of implementations of functional elements disclosed herein. In some examples, some or all portions of the functional elements disclosed herein may be performed by hardware specially configured for carrying out the functional elements.

In one or more examples, the diagram of system 900 may be used to implement various functions, operations, acts, processes, or methods disclosed herein. The system 900 includes one or more processors 902 operably coupled to one or more data storage devices, storage 904. The storage 904 includes machine executable code 906 stored thereon and the processor(s) 902 include logic circuit 908. The machine executable code 906 information describing functional elements that may be implemented or performed by the logic circuit 908. The logic circuit 908 may be adapted to implement or perform the functional elements described by the machine executable code 906.

The system 900, when executing the functional elements described by the machine executable code 906, may be considered as special purpose hardware configured for carrying out functional elements disclosed herein. In one or more examples, the processor(s) 902 may be configured to perform the functional elements described by the machine executable code 906 sequentially or concurrently on one or more different hardware platforms, or in one or more parallel process streams.

When implemented by logic circuit 908 of the processor(s) 902, the machine executable code 906 may adapt the processor(s) 902 to perform operations of examples disclosed herein. For example, by way of non-limiting example, the machine executable code 906 may adapt the processor(s) 902 to perform some or a totality of operations of one or more of scrambling codeword tables and encoding drive signals utilizing scrambled codeword tables.

The processor(s) 902 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer may execute functional elements corresponding to the machine executable code 906 including, but not limited to, software code, firmware code, and hardware descriptions related to one or more examples of the present disclosure. It is noted that a general-purpose processor, also referenced as a host processor or a host may be a microprocessor. Alternatively, the processor(s) 902 may include any conventional processor, controller, microcontroller, or state machine. The processor(s) 902 may also be implemented as a combination of computing devices, such as a combination of a DSP and a microprocessor, a plurality of microprocessors, one or more microprocessors in conjunction with a DSP core, or any other such configuration.

In one or more examples, the storage 904 includes, without limitation, volatile data storage including random-access memory (RAM), non-volatile data storage, such as, without limitation, flash memory, a hard disc drive, a solid state drive, and erasable programmable read-only memory (EPROM). In some examples, the processor(s) 902 and the storage 904 may be implemented into a single device, such as, without limitation, a semiconductor device, or a system on chip (SOC). In some examples, the processor(s) 902 and the storage 904 may be implemented into separate devices.

In some examples, the machine executable code 906 may include computer-readable instructions such as, without limitation, software code and firmware code. By way of non-limiting example, the computer-readable instructions may be stored by the storage 904, accessed directly by the processor(s) 902, and executed by the processor(s) 902 using at least the logic circuit 908. Also, by way of non-limiting example, the computer-readable instructions may be stored on the storage 904, transferred to a memory device (not shown) for execution, and executed by the processor(s) 902 using at least the logic circuit 908. Accordingly, in some examples, the logic circuit 908 may be electrically configurable.

In some examples the machine executable code 906 may describe hardware circuitry to be implemented in logic circuit 908 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, SystemVerilog™ or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits, such as, without limitation, gates, flip-flops, registers of the logic circuit 908 which may be described in an RTL and then converted by a synthesis tool into a GL description. The GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine executable code 906 may include an HDL, an RTL, a GL description, a mask level description, other hardware description, or any combination thereof.

In one or more examples, the machine executable code 906 may include a hardware description at any level of abstraction of a system (not shown), including the storage 904 which may be configured to implement the hardware description described by the machine executable code 906. By way of non-limiting example, the processor(s) 902 may include a programmable logic device, such as, without limitation, a field programmable gate array (FPGA) or a programmable logic circuit (PLC). The logic circuit 908 may be electrically controlled to implement circuitry corresponding to the hardware description described by the machine executable code 906. Also, by way of non-limiting example, the logic circuit 908 may include hard-wired logic manufactured by a manufacturing system (not shown) according to the hardware description of the machine executable code 906, where the manufacturing system includes the storage 904.

Regardless of whether the machine executable code 906 includes computer-readable instructions or a hardware description, the logic circuit 908 may be adapted to perform the functional elements described by the machine executable code 906. It must be recognized that although a hardware description may not directly describe functional elements, a hardware description may indirectly describe functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method of touch-screen overlay attack prevention, comprising:
obtaining a set of codewords scrambled based, in part, on a code division multiplexing (CDM) pattern;
generating drive signals encoded with the set of scrambled codewords; and
stimulating drive lines of a touch sensor in a touch screen over multiple measurement frames utilizing different patterns of the set of scrambled codewords for respective ones of the multiple measurement frames.

2. The method of claim 1, wherein obtaining the scrambled codeword comprises:
selecting, at least partially based on a selection process that is randomized, one or more scrambler operators from a set of scrambling operators; and
converting a codeword according to the selected one or more scrambler operators to generate the scrambled codeword.

3. The method of claim 2, wherein the selecting at least partially based on the selection process that is randomized comprises:
obtaining a value responsive to the randomized selection process, wherein the obtained value is one of a true random value or pseudo-random value; and
determining a selection of the one or more scrambling operators from the set of scrambling operators at least partially based on the obtained value.

4. The method of claim 2, comprising:
receiving encoded sense signals from the touch sensor; and
touch-processing the received encoded sense signals at least partially based on the scrambled codeword.

5. The method of claim 2, wherein the set of scrambling operators comprises one or more of shuffling, inverting codeword rows, inverting codeword columns, or inserting invalid patterns.

6. The method of claim 1, wherein at least some respective ones of the different patterns of codewords are orthogonal to at least some other respective ones of the different patterns of codewords.

7. The method of claim 6, wherein stimulating drive lines of the touch sensor over multiple measurement frames utilizing different patterns of codewords for respective ones of the multiple measurement frames comprises:
generating a first set of codewords and a second set of codewords;
scrambling the first set of codewords according to one or more first scrambling operators;
scrambling the second set of codewords according to one or more second scrambling operators, wherein the one or more second scrambling operators are different than the one or more first scrambling operators;
encoding a first drive pattern utilizing the scrambled first codeword set;
encoding a second drive pattern utilizing the scrambled second codeword set;
stimulating drive lines of a touch sensor over a first measurement frame utilizing the encoded first drive pattern; and
stimulating drive lines of the touch sensor over a second measurement frame utilizing the encoded second drive pattern, wherein the second measurement frame is different than the first measurement frame.

8. The method of claim 7, comprising:
selecting the first scrambling operator and the second scrambling operator, respectively, from the set of one or more scrambling operators including one or more of shuffling, inverting codeword rows, inverting codeword columns, or inserting invalid patterns.

9. The method of claim 8, wherein the shuffling comprises one or more of rearranging a row of codewords and rearranging a column of codewords.

10. The method of claim 9, wherein inverting codeword rows comprises one or more of inverting some symbols or a totality of symbols of some or a totality of codeword rows.

11. The method of claim 10, wherein inverting codeword columns comprises one or more of inverting some symbols or a totality of symbols of some or a totality of codewords columns.

12. The method of claim 7, wherein the touch sensor is a portion of a capacitive touch sensing system.

13. The method of claim 12, wherein the stimulating drive lines of the touch sensor over multiple measurement frames utilizing different patterns of codewords for respective ones of the multiple measurement frames comprises:
stimulating drive lines of the touch sensor utilizing first codewords during a first measurement frame of the multiple measurement frames; and
stimulating drive lines of the touch sensor utilizing second codewords during a second measurement frame of the multiple measurement frames,
wherein a pattern of the second codewords is different than a pattern of the first codewords, and
wherein the second measurement frame is different than the first measurement frame.

14. An apparatus for overlay attack prevention, comprising:
at least one processor; and
a data storage device operatively connected to the at least one processor to store machine executable code which, when executed, enables the at least one processor to perform acts comprising:
obtaining a codeword scrambled based, at least in part, on a code division multiplexing (CDM) pattern;
combining a drive signal with the scrambled codeword to generate an encoded drive signal; and
stimulating drive lines of a touch sensor over multiple measurement frames utilizing different patterns of codewords for respective ones of the multiple measurement frames.

15. The apparatus of claim 14, wherein the acts comprise:
selecting one or more scrambling operators responsive to a selection process that is randomized;
scrambling the codeword according to the selected one or more scrambling operators; and
utilizing the encoded drive signal to stimulate a drive line of the touch sensor.

16. The apparatus of claim 15, wherein the acts comprise:
selecting, for the randomized selection process, the one or more scrambling operators at least partially responsive to a value that is one of a true random value or pseudo-random value.

17. The apparatus of claim 15, wherein the acts comprise:
selecting the one or more scrambling operators from a set of scrambling operators,
the set of scrambling operators including one or more of shuffling, inverting codeword rows, inverting codeword columns, or inserting invalid patterns.

18. The apparatus of claim 15, wherein the acts comprise:
receiving sensed signals from the touch sensor; and
touch-processing the received sensed signals at least partially based on a scrambled codeword.

19. The apparatus of claim 18, wherein the act of stimulating drive lines of the touch sensor over multiple measurement frames utilizing different patterns of codewords for respective ones of the multiple measurement frames, comprises:
generating a first codeword and a second codeword;
scrambling the first codeword according to a first scrambling operator;
scrambling the second codeword according to a second scrambling operator, wherein the first scrambling operator is different than the second scrambling operator;
encoding a first drive signal utilizing the scrambled first codeword;
encoding a second drive signal utilizing the scrambled second codeword;
stimulating a drive line of a touch sensor over a first measurement frame utilizing the encoded first drive signal; and
stimulating the drive line of the touch sensor over a second measurement frame utilizing the encoded second drive signal, wherein the second measurement frame is different than the first measurement frame.

20. The apparatus of claim 19, wherein the touch sensor is at least a portion of a capacitive touch sensing system.

21. The apparatus of claim 16, wherein at least some respective ones of the patterns of the different patterns of codewords are orthogonal to at least some other respective ones of the different patterns of codewords.

22. An apparatus, comprising:
a codeword generator to generate codewords;
a scrambler to generate codewords scrambled for respective measurement frames of a touch sensing system at least partially based on the codewords generated by the code generator and a code division multiplexing (CDM) pattern; and
a driver to generate drive signals at least partially based on the scrambled codewords generated by the scrambler.

23. The apparatus of claim 22, wherein the scrambler to:
select one or more scrambling operators at least partially based on a selection process that is randomized; and
generate a scrambled codeword at least partially based on the randomized selection process, wherein the randomized selection process obtains a value that is one of a true random value or pseudo-random value.

24. The apparatus of claim 23, wherein the scrambler to:
select the one or more scrambling operators from a set of scrambling operators, the set of scrambling operators comprising one or more of shuffling, inverting codeword rows, inverting codeword columns, or inserting invalid patterns.

25. The apparatus of claim 23, comprising:
a touch controller to touch-process received sensed signals at least partially based on the scrambled codewords.

26. The apparatus of claim 23, wherein the scrambler generates at least some scrambled codewords, wherein each scrambled codeword remains orthogonal to another scrambled codeword.

27. A system, comprising:
a touch sensor; and
a touch controller to:
obtain codewords for respective measurement frames of the touch sensor;
scramble respective codewords according to different patterns of codewords; and
perform a capacitive measurement of the touch sensor at least partially based on each respective scrambled codeword.

28. The system of claim 27, wherein the touch controller to:
obtain a first codeword set;
scramble the first codeword set according to a first scrambling operator;
encode a first drive signal utilizing the scrambled first codeword set;
stimulate a drive line of a touch sensor over a first measurement frame utilizing the encoded first drive signal;
obtain a second codeword set;
scramble the second codeword set according to a second scrambling operator, wherein
the second scrambling operator is different from the first scrambling operator;
encode a second drive signal utilizing the scrambled second codeword set; and
stimulate the drive line of the touch sensor over a second measurement frame utilizing the encoded second drive signal, wherein the second measurement frame is different than the first measurement frame.
